(19) United States
(12) Patent Application Publication
(10) Pub. No.: US 2005/0154236 A1
(43) Pub. Date: Jul. 14, 2005

(54) Method for producing shell catalysts

(75) Inventor: Dominic Vanoppen, Kapellen (DE)

Correspondence Address: OBLON, SPIVAK, MCCLELLAND, MAIER & NEUSTADT, P.C., 1940 DUKE STREET, ALEXANDRIA, VA, 22314, US

(73) Assignee: BASF AKTIENGESELLSCHAFT, LUDWIGSHAFEN (DE)

(21) Appl. No.: 10/504,316

(22) PCT Filed: Feb. 25, 2003
(86) PCT No.: PCT/EP03/01892

(30) Foreign Application Priority Data
Feb. 26, 2002 (DE) 102 08 113.1

(51) Int. Cl. B01J 23/40; B01J 21/18; B01J 23/02

(52) U.S. Cl. 564/489; 502/261; 502/333; 502/182; 502/178; 502/184; 502/185; 502/200

(57) ABSTRACT

Coated catalysts which comprise at least one catalytically active metal on an inorganic or carbon support are prepared by mixing a solid, preferably vaporizable, precursor material of the at least one catalytically active metal with the inorganic support and heating the mixture obtained in this way with further mixing until no more separate solid precursor material is present, preferably to a temperature at which the precursor material vaporizes. Such coated catalysts may in particular be used in hydrogenations.

The present invention relates to a process for preparing coated catalysts which comprise at least one catalytically active metal on an inorganic or carbon support.

Coated catalysts may be obtained by various processes. For example, inorganic supports may be impregnated with a metal salt solution of the catalytically active metal which may be followed by a drying and reduction step. In the case of coated catalysts which comprise ruthenium on silicon dioxide in particular, it is difficult to obtain narrow coating profiles by the classical impregnating process. However, a pronounced coating profile offers advantages with regard to internal mass transfer when using the catalyst and thus allows the preparation of generally more active and more selective fixed bed catalysts.

In the case of catalysts prepared by classical impregnation processes, especially Ru catalysts, the reuse of the catalyst in a second application experiment generally also leads to a marked fall in the activity of the catalyst. However, the activity stabilizes after the second experiment. This behavior can be attributed to the initial detachment of Ru colloids in the case of freshly prepared catalyst. The hydrogenation-active fluid is in permanent contact with the material to be treated during the first use of the catalyst and thus ensures an apparently higher activity. However, it is desirable for practical applications to obtain a very substantially constant catalyst activity over the lifetime of the catalyst.

DE-A 198 27 844 describes a process for preparing coated catalysts having a defined coat thickness on porous ceramic supports. In this process, the support material is prepared with precursors which can be vaporized without decomposition by the chemical vapor deposition (CVD) process with subsequent fixing of the metals by simultaneous or subsequent thermal or chemical reduction. Useful precursors are in particular allyl/cyclopentadienylpalladium and trimethylphosphine(methyl)gold. In the process, the coating thickness can be controlled and adapted to the catalytic requirements. In CVD processes, the compound of the catalytically active metal is vaporized and deposited on the solid support from the vapor phase. In this case, operation is effected using a carrier gas at reduced pressures of down to 10⁻⁴ torr. The temperature of the furnace is generally in the range from 20 to 600° C., while the temperature of the reservoir is in the range from 20 to 100° C. The reduction of the catalyst precursor to the catalyst may be achieved by using hydrogen as the carrier gas or by using separate reducing agents. The procedure of the CVD process is complicated, since the vaporized metal precursor has to be conveyed onto the catalyst support by means of a carrier gas. In addition, the process is not universally applicable to metal precursors, since not all noble metal precursors exhibit a suitable vaporization behavior.

It is an object of the present invention to provide a process for preparing coated catalysts which allows the formation of narrow coating profiles in the coated catalyst in an uncomplicated manner. In addition, the catalysts obtained should preferably exhibit a less marked deactivation behavior on reuse of the catalyst compared to catalysts obtained by customary processes.

It is also desirable that the catalysts be more active and/or selective than fixed bed catalysts prepared by known processes.

We have found that this object is achieved by a process for preparing coated catalysts which comprise at least one catalytically active metal on an inorganic or carbon support by mixing at least one solid, preferably vaporizable, precursor material of the at least one catalytically active metal with the inorganic support and heating the mixture obtained in this way with further mixing until there is no more separate solid precursor material, preferably to a temperature at which the precursor material vaporizes.

Preference is given to carrying out the mixing in a rotary kiln or other moving kilns or kilns equipped with mixing internals. The mixing of the at least one solid vaporizable precursor material of the at least one catalytically active metal with the inorganic or carbon support and the common heating of the mixture up to a temperature at which the precursor material interacts with the carrier, in particular vaporizes, leads to a combination of in particular solid-solid reactions of the (volatile) precursor materials with the inorganic or carbon support material, combined with additional liquid-solid transitions and gaseous-solid transitions. The solid-solid contact in particular distinguishes the process according to the invention from a CVD process in which exclusively a gaseous-solid reaction takes place. In addition, the inorganic or carbon support material and the solid (vaporizable) precursor material of the at least one catalytically active metal are handled in a heatable mixing apparatus, so that the procedure can be simplified.

The mixing is carried out until such time as the precursor material has been completely taken up by the support material, so that there is no more separate solid precursor material. The mixing apparatus ensures a marked solid-solid contact and solid-solid transition in the mixture during the heating. Any mixing apparatus suitable for this purpose may be used according to the invention. Typically, the heating is effected from room temperature (20° C.) to a maximum temperature in the range of up to 600° C., more preferably up to 400° C.

The solid (vaporizable) precursor material of the at least one catalytically active metal and the inorganic or carbon support are preferably introduced into the mixing apparatus in a form which allows intensive solid-solid contact. This means that the external surface of the materials should be high. The inorganic or carbon support is therefore preferably used in the form of shaped bodies, granules, extrudates, pellets, spall, tablets or prills. The solid (vaporizable) precursor material is preferably used in powder form. The mixing apparatus may comprise additional internals or, for example, spheres which make the mixing procedure more intensive.

The inorganic or carbon support and the solid (vaporizable) precursor material are preferably used in an amount which corresponds to the ratio of the amount of the catalytically active material to the inorganic or carbon support in the subsequent catalyst. Preference is given to using the solid (vaporizable) precursor material in such an amount that the proportion of the catalytically active metal in the finished catalyst is from 0.01 to 10% by weight, more preferably from 0.02 to 2% by weight, based on the total weight of the catalyst.

Preference is given to selecting the inorganic support from SiO₂, Al₂O₃, TiO₂, ZrO₂, MgO, mixed oxides or mixtures thereof, SiC and Si₃N₄. The inorganic or carbon support may be present, for example, in the form of spheres, tablets, rings, stars or other shaped bodies. The diameter or the length and thickness of the inorganic or carbon support particles is preferably in the range from 0.5 to 15 mm, more preferably from 3 to 9 mm. The surface area of the support may be freely selected depending on the practical considerations for the particular application case. The surface area of the support is preferably from 10 to 2000 m²/g. The surface of the inorganic support, determined by the BET method, is preferably from 10 to 500 m²/g, more preferably from 20 to 250 m²/g. The pore volume may likewise be freely selected depending on the field of application. The pore volume is preferably from 0.2 to 2 ml/g, more preferably from 0.3 to 1.2 ml/g. Suitable supports are known to those skilled in the art.

In one embodiment of the invention, the solid, preferably vaporizable, precursor material of the at least one catalytically active metal comprises the metal in the oxidation state 0. In this case, a subsequent reduction of the precursor material can be dispensed with, since the precursor material decomposes on the inorganic or carbon support and deposits the catalytically active metal directly in metallic form. For example, metal carbonyls may be used as the vaporizable precursor materials, as long as they interact sufficiently with the support or are volatile, in order to facilitate takeup. For example, triruthenium dodecacarbonyl is a ruthenium source which is sufficiently volatile and contains the ruthenium in the redox state 0. However, it is also possible in the case of such (vaporizable) precursor materials to additionally use reducing agents which may either be present on the inorganic or carbon support or be applied at the same time or after application of the (vaporizable) precursor material. When the metals are used in the oxidation state 0, it is sometimes possible to achieve even narrower profiles than is the case when using metals in other oxidation states. Preimpregnation of the catalyst support with a reducing agent may lead to a further narrowing of the profile.

Examples of solid vaporizable precursor materials of the at least one catalytically active metal in which the metal is present in the oxidation state 0 include, in addition to Ru₃(CO)₁₂, carbonyls of Re, Co and Ni, metallocenes of Ru, Co and Ni, and cyclopentadienyls of Co, Rh, Ir, Cu and Ag.

In a further embodiment of the invention, the solid, preferably vaporizable, precursor material of the at least one catalytically active metal may comprise the metal in the oxidation state +1 or higher. In this case, the inorganic or carbon support preferably comprises a reducing agent for the metal and is used in this form for preparing the catalyst according to the invention.

The at least one catalytically active metal is preferably selected from Pd, Au, Pt, Ag, Rh, Re, Ru, Cu, Ir, Ni, Co and mixtures thereof, more preferably selected from Ru, Pd, Pt, Ag, Rh and Au, in particular from Ru, Pd and Pt.

Examples of suitable precursors are metal compounds or complexes which comprise silyl, halogen, acetylacetonate, hexafluoroacetylacetonate, cyclopentadiene, trifluoroacetylacetonate, alkyl, aryl or CO as components. Examples of suitable Pd precursors include Pd(allyl)₂, Pd(C₄H₇)acac, Pd(CH₃allyl)₂, Pd(hfac)₂, Pd(hfac)(C₃H₅), Pd(C₄H₇)(hfac) and PdCp(allyl), in particular PdCp(allyl), (acac=acetylacetonate, hfac=hexafluoroacetylacetonate, Cp=cyclopentadienyl, tfac=trifluoroacetylacetonate, Me=methyl).

Examples of suitable Au precursors include Me₂Au(hfac), Me₂Au(tfac), Me₂Au(acac), Me₃Au(PMe₃), CF₃Au(PMe₃), (CF₃)₃Au(PMe₃), MeAuP(OMe)₂Bu^{t}, MeAuP(OMe)₂Me and MeAu(PMe₃). Preference is given to Me₃PAuMe.

Examples of suitable Ru precursor materials include Ru(acac₃) and Ru₃(CO)₁₂.

Further suitable precursor materials are also known from CVD applications.

The reducing agents with which the inorganic or carbon supports may, for example, be impregnated may be a solution of an organic or inorganic reducing agent. For example, the reducing agent may be selected from ammonium formate and sodium borohydride. Particular preference is given to using ammonium formate as the reducing agent, in which case the support is saturated with an ammonium formate solution before preparing the coated catalyst. It is also possible to carry out other thermal or chemical reduction processes which can be used for fixing the metals.

The amount of reducing agent, in particular ammonium formate, is selected in accordance with the practical requirements. The amount is preferably selected in such a way that a complete reduction of the catalytically active metal is possible under the preparation conditions.

It is also possible according to the invention to load the coated catalyst prepared by impregnation or other processes with further active components, promoters or assistants. Particular preference is given to applying all catalytically active metals to the inorganic support by the process according to the invention. The choice of suitable organic ligands of the metal allows the ligands to be removed from the coated catalyst, for example, by applying reduced pressure or the action of elevated temperature, so that no residue of the precursor material remains in the catalyst. This prevents contamination of the coated catalyst.

The process parameters such as amounts of the starting materials, temperature profile, contact time, etc., allow simple control and variation of the coating thickness which can therefore be adapted to the practical requirements. Compared to CVD processes, the use of a carrier gas and the complicated handling of the precursors in this process can be dispensed with.

The process according to the invention makes it possible to obtain coated catalysts having a substantially narrower coating profile than was hitherto possible. In addition, the metal dispersion and uniformity of the coating are improved. It is possible to prepare substantially monomodal and narrow-band particle size distributions having very small particles. The average particle diameter of the catalytically active metals is preferably from 1 to 100 nm, more preferably from 2 to 10 nm.

The process according to the invention additionally allows the coating thickness and the concentration of the catalytically active metal to be adapted to the particular requirements and controlled. When suitable organometallic precursor compounds are used, the residue-free fixing of the catalytically active metals to the inorganic support is possible.

Preferred coating thicknesses are in the range from 1 to 750 μm, more preferably from 5 to 300 μm.

Compared to fully saturated catalysts, the proportion of active metal in the catalysts according to the invention can be reduced without impairing the catalyst performance. In addition, it is possible to provide more active and selective catalysts for highly differing reactions.

The present invention also relates to a coated catalyst which is obtainable by the present process.

The coated catalysts according to the invention may be used for all suitable applications. Preference is given to using them in hydrogenations. This is true in particular for catalysts which comprise ruthenium, palladium or platinum as the catalytically active metals.

The catalysts according to the invention exhibit a distinctly less marked deactivation behavior than catalysts prepared by conventional processes. When the catalysts are used, no colloid of the catalytically active metal in the solution is observed. It is clear from this that no colloids are released from the freshly prepared catalyst.

The invention is illustrated by the examples hereinbelow.

### EXAMPLES

### Example 1

### 1% Ru/SiO₂ Catalyst

SiO₂ extrudates [diameter 3 mm] were initially saturated with an ammonium formate solution (5% of ammonium formate, based on the support) and then dried. The material obtained together with 1% of Ru(acac)₃, based on the metal, was installed as a solid in a rotary kiln and heated to 110° C. for 4 hours and then to 300° C. within 100 min and maintained at this temperature for 4 hours. At this temperature, the Ru(acac)₃ vaporizes, migrates onto the extrudates and is reduced by ammonium formate. This leads to the formation of a very narrow coating profile.

The coating thickness was about 300 μm.

Without the preimpregnation of the support with ammonium formate, only some of the acetylacetonate decomposes on the catalyst surface and forms a less pronounced profile. The remaining portion of the ruthenium is deposited as a fine black powder between the extrudates or discharged from the kiln with the gas stream as the acetylacetonate.

The catalyst obtained according to the invention comprised 1% of Ru on SiO₂ as the support.

For comparative purposes, a catalyst was prepared by impregnation of the SiO₂ support with a ruthenium salt solution and subsequent reduction.

The catalyst according to the invention and the comparative catalyst were used for hydrogenating dextrose to sorbitol. The depletion was determined once on a freshly prepared catalyst and then on a reused catalyst. The results are summarized in the following table.

TABLE 1

| | 1% of Ru/SiO₂ | 1% of Ru/SiO₂ |
|---|---|---|
| Catalyst | (impregnation) | (invention) |
| Depletion: fresh | conversion = 93-96% | conversion = 95% |
| Catalyst hourly space | mannitol = 0.4-0.7% | mannitol = 0.8% |
| velocity = 0.66 g | | |
| of dextrose/(g of cat. h) | | |
| Depletion: reused | conversion = 85-88% | conversion = 95% |
| Catalyst hourly space | mannitol = 0.4-0.6% | mannitol = 1.0% |
| velocity = 0.66 g | | |
| of dextrose/(g of cat. h) | | |

The catalyst according to the invention comprised predominantly Ru particles having measurements in the range from 2 to 100 nm.

### Example 2

### 0.025% of Pd on High-Temperature-Calcined Al₂O₃

The Pd/Al₂O₃ catalyst was prepared as follows:

The support was initially impregnated with 5% of ammonium formate as in Example 1 and dried. 0.025% of Pd in the form of Pd(acac)₂ were then mixed with the support and heated to 300° C. at 10° C./min. in the rotary kiln and maintained at 300° C. for 1 hour.

This catalyst was tested in the C₂ hydrogenation. The selectivity of the Pd/Al₂O₃ catalysts prepared by classical impregnation processes was substantially exceeded (30% compared to from 10 to 15% for the comparative catalyst).

### Example 3

### 1% of Ru/SiO₂

The catalyst was prepared from SiO₂ and triruthenium dodecacarbonyl as follows:

1% of Ru as Ru₃(Co)₁₂ was initially charged with 3 mm SiO₂ extrudates in a rotary kiln and heated to 300° C. in one hour and maintained at this temperature for 2 hours.

The SiO₂ support was not preimpregnated with a reducing agent.

TEM micrographs of the catalyst show an Ru particle size of from about 2 to 5 nm. The activity in the dextrose hydrogenation was tested in a depletion experiment. In this experiment, a distinct increase in the activity in comparison to conventionally impregnated catalysts could be detected, although the Ru content was low. The results are summarized in the following Table 2:

TABLE 2

| | 1% of Ru/SiO₂ | 0.64% of Ru/SiO₂ |
|---|---|---|
| Catalyst | (impregnation) | (invention) |
| Depletion: fresh | conversion = 92-95% | conversion = 99.4% |
| Catalyst hourly space | mannitol = 0.4-0.7% | mannitol = 1.2% |
| velocity = 0.74 g | | |
| of dextrose/(g of cat. h) | | |
| Depletion: reused | conversion = 90% | conversion = 99.6% |
| Catalyst hourly space | mannitol = 0.4-0.6% | mannitol = 1.2% |
| velocity = 0.6 g of | | |
| dextrose/(g of cat. h) | | |

In this case also, distinctly less marked deactivation behavior could be detected on reuse. Also, no colloid was observed in the solution.

1. A process for preparing coated catalysts which comprise at least one catalytically active metal on an inorganic or carbon support the process comprising:
mixing at least one solid precursor material of the at least one catalytically active metal with the inorganic support to obtain a mixture and
heating the mixture with further mixing until there is no more separate solid precursor material.

2. A process as claimed in claim 1, wherein the mixing is carried out in a rotary kiln or other moving kilns or kilns equipped with mixing internals.

3. A process as claimed in claim 1, wherein the inorganic or carbon support is u in the form of shaped bodies, granules, extrudates, pellets, spall, tablets or prills.

4. A process as claimed in claim 1, wherein the inorganic support is selected from the group consisting of SiO₂, Al₂O₃, TiO₂, ZrO₂, MgO, mixed oxides, mixtures of said mixed oxides, SiC, Si₃N₄ and mixtures thereof.

5. A process as claimed in claim 1, wherein the solid precursor material of the at least one catalytically active metal comprises the metal in the oxidation state 0.

6. A process as claimed in claim 1, wherein the solid precursor material of the at least one catalytically active metal comprises the metal in the oxidation state +1 or higher and the inorganic support comprises a reducing agent for the metal.

7. A process as claimed in claim 6, wherein the reducing agent is ammonium formate.

8. A process as claimed in claim 1, wherein the solid precursor material is vaporizable and the mixture is heated to a temperature at which the precursor material vaporizes.

9. A process as claimed in claim 1, wherein the catalytically active metal is selected from the group consisting of Pd, Au, Pt, Ag, Rh, Re, Ru, Cu, Ir, Ni, Co and mixtures thereof.

10. A coated catalyst produced by the process as claimed in claim 1.

11. A method of hydrogenating a compound comprising:
placing the compound in contact with the coated catalyst as claimed in claim 10, and hydrogenating said compound.
